(19) United States
(12) Patent Application Publication
(10) Pub. No.: US 2026/0210212 A1
(43) Pub. Date: Jul. 23, 2026

(54) DISPOSING VITRIFIED WASTE

(71) Applicant: Deep Isolation, Inc., Berkeley, CA (US)

(72) Inventor: Richard A. Muller, Berkeley, CA (US)

(21) Appl. No.: 19/144,094

(22) PCT Filed: Jan. 18, 2024
(86) PCT No.: PCT/US2024/012000

§ 371 Date: Jun. 27, 2025

Related U.S. Application Data
(60) Provisional application No. 63/480,648, filed on Jan. 19, 2023.

(51) Int. Cl. E21B 41/00; G21F 9/34

(52) U.S. Cl. CPC E21B 41/005; G21F 9/34

(57) ABSTRACT

A hazardous waste repository includes a drillhole formed from a terranean surface and through one or more subterranean formations. The drillhole includes a storage portion formed within at least one of the one or more subterranean formations. The hazardous waste repository includes a portion of vitrified hazardous waste enclosed in a housing of at least one high level waste canister (HLWC) exclusive of an outer canister. The HLWC is positioned in the storage portion.

### TECHNICAL FIELD

This disclosure relates to systems and methods for disposing vitrified waste and, more particularly, disposing vitrified nuclear waste in a drillhole formed in a subterranean formation.

### BACKGROUND

Hazardous waste is often placed in long-term, permanent, or semi-permanent storage so as to prevent health issues among a population living near the stored waste. Such hazardous waste storage is often challenging, for example, in terms of storage location identification and surety of containment. For instance, the safe storage of nuclear waste (e.g., spent nuclear fuel, whether from commercial power reactors, test reactors, or even military waste) is considered to be one of the outstanding challenges of energy technology. Safe storage of the long-lived radioactive waste is a major impediment to the adoption of nuclear power in the United States and around the world. Conventional waste storage methods have emphasized the use of tunnels and is exemplified by the design of the Yucca Mountain storage facility. Other techniques include boreholes, including vertical boreholes, drilled into crystalline basement rock. Other conventional techniques include forming a tunnel with boreholes emanating from the walls of the tunnel in shallow formations to allow human access.

### SUMMARY

In an example implementation, a hazardous waste repository includes a drillhole formed from a terranean surface and through one or more subterranean formations. The drillhole includes a storage portion formed within at least one of the one or more subterranean formations. The hazardous waste repository includes a portion of vitrified hazardous waste enclosed in a housing of at least one high level waste canister (HLWC) exclusive of an outer canister. The HLWC is positioned in the storage portion.

In an aspect combinable with the example implementation, the housing of the HLWC is solely insufficient to withstand a hydrostatic pressure present in the storage portion without deformation, and a housing of the outer canister is solely sufficient to withstand the hydrostatic pressure present in the storage portion without deformation.

In another aspect combinable with any of the previous aspects, the housing of the HLWC is approximately 45 cm in diameter.

In another aspect combinable with any of the previous aspects, the vitrified hazardous waste includes at least one of vitrified nuclear waste, vitrified chemical waste, vitrified biological waste, or a crush resistant waste package.

In another aspect combinable with any of the previous aspects, the nuclear waste includes at least one of: Cesium-137 or Strontium-90 capsules; spent nuclear fuel pellets; vitrified nuclear waste that includes glass-encased nuclear fuel; one or more fragments of a melted nuclear core; calcine waste that includes a granular solid; pebble bed nuclear reactor pellets; or a portion of transuranic waste.

In another aspect combinable with any of the previous aspects, the housing of the HLWC includes an attachment member formed at or coupled to an end of the housing.

In another aspect combinable with any of the previous aspects, the attachment member includes a knob.

In another aspect combinable with any of the previous aspects, the attachment member is configured to attach to a downhole conveyance.

In another aspect combinable with any of the previous aspects, the downhole conveyance includes one of a wireline, slickline, coiled tubing, drill pipe, or downhole tractor.

Another aspect combinable with any of the previous aspects further includes a casing installed in the drillhole.

Another aspect combinable with any of the previous aspects further includes a seal positioned in the drillhole.

In another example implementation, a method of storing hazardous waste includes identifying a drillhole formed from a terranean surface and through one or more subterranean formations. The drillhole includes a storage portion formed within at least one of the one or more subterranean formations. The method includes moving a portion of vitrified hazardous waste enclosed in a housing of a high level waste canister (HLWC) exclusive of an outer canister into position in the storage portion.

In an aspect combinable with the example implementation, the housing of the HLWC is solely insufficient to withstand a hydrostatic pressure present in the storage portion without deformation, and a housing of the outer canister is solely sufficient to withstand the hydrostatic pressure present in the storage portion without deformation.

In another aspect combinable with any of the previous aspects, the housing of the HLWC is approximately 45 cm in diameter.

In another aspect combinable with any of the previous aspects the vitrified hazardous waste includes at least one of vitrified nuclear waste, vitrified chemical waste, vitrified biological waste, or a crush resistant waste package.

In another aspect combinable with any of the previous aspects, the nuclear waste includes at least one of: Cesium-137 or Strontium-90 capsules; spent nuclear fuel pellets; vitrified nuclear waste that includes glass-encased nuclear fuel; one or more fragments of a melted nuclear core; calcine waste that includes a granular solid; pebble bed nuclear reactor pellets; or a portion of transuranic waste.

Another aspect combinable with any of the previous aspects includes coupling a downhole conveyance to an attachment member formed at or coupled to an end of the housing of the HLWC.

In another aspect combinable with any of the previous aspects, the attachment member comprises a knob.

Another aspect combinable with any of the previous aspects includes moving the HL WC on the downhole conveyance through the drillhole while coupled to the attachment member.

In another aspect combinable with any of the previous aspects, the downhole conveyance includes one of a wireline, slickline, coiled tubing, drill pipe, or downhole tractor.

In another aspect combinable with any of the previous aspects, the drillhole further includes a casing installed in the drillhole.

In another aspect combinable with any of the previous aspects, the drillhole further includes a seal positioned in the drillhole.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic illustration of an example implementation of a hazardous waste repository according to the present disclosure.

FIG. 2 is a schematic illustration of an example implementation of a crush-resistant hazardous waste canister that encloses hazardous waste in a hazardous waste repository according to the present disclosure.

FIG. 3 is a schematic illustration of an example implementation of a hazardous waste cask that encloses a high-level waste canister (HLWC) that encloses hazardous waste in a mined hazardous waste repository.

FIG. 4 is a schematic illustration of an example implementation of a high-level waste canister (HLWC) that encloses vitrified hazardous waste in a hazardous waste repository according to the present disclosure.

### DETAILED DESCRIPTION

Hazardous waste (e.g., radioactive, nuclear, chemical, biological, and otherwise) can be disposed in deep, human-unoccupiable boreholes (i.e., drillholes or wellbores). Safety to the public is typically provided by both engineered and geologic barriers. The danger to the public comes from the fact that a hazardous chemical in the waste can dissolve in the brine (or other forms of water) that exist in deep rock formations. This brine can be in motion, and it can carry the dissolved waste to the biosphere where it can come in contact with humans. For example, in spent nuclear fuel, radioactive waste including iodine-129 and chlorine-36 have sufficient lifetimes that they can be carried into near surface aquifers by the flow of brines. Historically, more troublesome is the existence of potential “fast paths” to the surface which could offer rapid pathways for the waste to reach the surface. To protect the public, two generic approaches are taken, often referred to as engineered confinement and geologic confinement.

Engineered confinement in some instances refers to a canister that contains the waste. This can be a tube or spherical container designed to hold the waste and to keep it from contact with the brine for as long a time period as is practical. To do that, the canister is, in prior work, made resistant to corrosion and impact. Corrosion resistance can come from the use of corrosion resistant material, either in the walls of the canister or as a coating for the canister. In addition, the hydrostatic pressure of the brines can be very high, typically 1 atmosphere for every 10 meters of depth. Thus, for a 1.5 km depth, the canister must be strong enough to withstand 150 atmospheres, which requires a thick and heavy canister able to withstand such pressure without experiencing crush failure or deformation that can release waste into the formation.

Geologic confinement refers to an overburden of rock that is sufficiently thick and impermeable that upward flow of brine is sufficiently slow that dangerous levels of waste will not reach the human environment (such as fresh-water aquifers) for thousands to millions of years. For radioactive waste, much of the waste will convert to non-hazardous isotopes before it can reach the surface. But geologic confinement can be circumvented by the existence of fast paths. These include existing earthquake faults, future earthquake faults, and the borehole itself (which is formed from the surface into the formation in which the waste is stored). The belief that a borehole is a fast path has received a great deal of attention in the past because of the challenge of sealing it in a way that will offer protection for thousands to millions of years. Traditional seal materials include cement, concrete, and bentonite. But it is difficult, perhaps impossible, to know what will happen to such sealants over periods of hundreds to thousands to millions of years. In the United States, safety of the public must be assured for up to a million years.

The engineered barrier, in some implementations, is a canister designed to take hundreds to thousands of years to corrode. Since boreholes typically fill rapidly with brine or other forms of water, the canister is also designed to withstand the pressure that such brine can create. In other words, it must be resistant to crushing. To address these issues, thick, heavy canisters (i.e., a canister which housing can withstand pressure at a storge depth without deforming or being crushed) have been proposed.

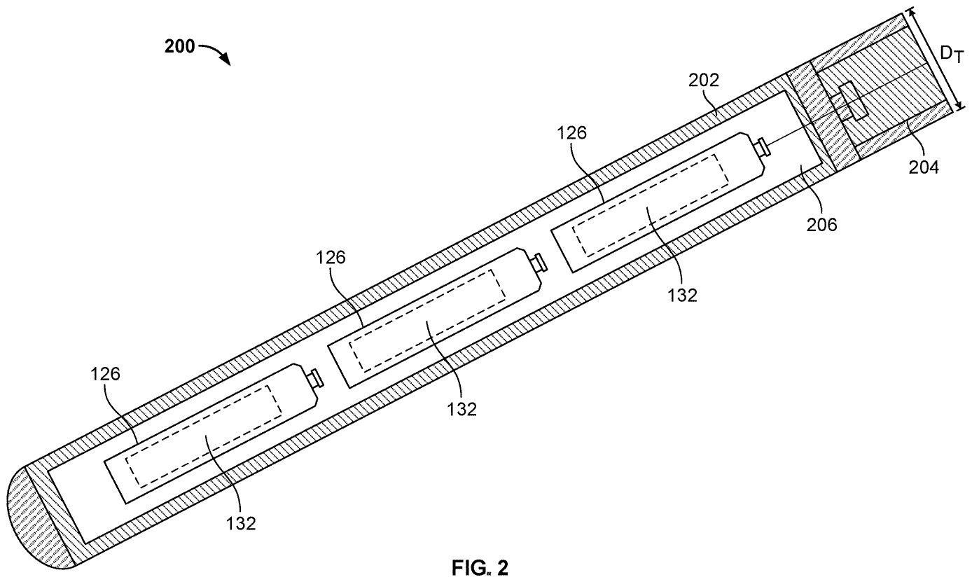

The present disclosure describes example implementations of systems and methods for a hazardous waste repository in which vitrified waste is moved into and stored (temporarily or permanently) within a drillhole (e.g., borehole or wellbore) formed from a terranean surface into a subterranean formation, in which the vitrified waste is independent of (i.e., not enclosed within) a hazardous waste canister (i.e., a thick (outer) canister shown in FIG. 2). These implementations take advantage of important insights that are not recognized by those who are practice in the field of nuclear waste disposal. These are:

Fast paths do not create a significant hazard to the public. The reason is that they tend to be thin (as in an earthquake fault) or cylindrical in shape (as in the access borehole). Studies done by the assignee of this application have shown that for sufficiently deep disposal, diffusion outwards from the “fast path” depletes the waste so rapidly as a function of vertical motion that the waste that reaches the surface is well below the regulatory limits.

At depths of 500 meters to 1500 meters and deeper, in a manner that depends on the specific geology of a site, the geologic barrier is sufficiently effective that an engineered barrier is not necessary. This has been demonstrated by careful simulations done the assignee of this application. These simulations show that “instant release” of the canister after initial sealing of the borehole gives sufficient protection for humans that no long-term engineered barrier is required to reach the stringent limits of U.S. government regulations. Further, geochemical techniques can be used to demonstrate that geologic safety alone (with no account taken for engineered barriers) can be sufficient to guarantee safety.

Conventional canisters designed to store hazardous waste at depth are designed to be capable of resisting crushing during the emplacement phase, and prior canister designs include a “thick canister” wall that is sufficient to withstand the hydrostatic pressures present at the disposal depth, typically 100 atmospheres of pressure for each kilometer of depth. The disclosed implementations take advantage of the fact that in many instances, the hazardous waste itself provides sufficient resistance to such crushing that no thick canister is required.

When these insights are recognized and combined in an innovate way, the resulting implementations described herein allow for significantly reduced cost, not only in the canister but also in the borehole. In another insight, since the geologic barrier by itself offers sufficient safety to the public, there is no need to include a thick outer canister as an engineered barrier.

For hazardous (e.g., radioactive or nuclear) waste that is not already in a single solid piece, it can be put in such a form thorough the same vitrification process that is used for spent nuclear fuel. As one instance, small chunks of other waste, including pieces of “corium” (waste from nuclear reactor meltdown that has been solidified and broken into small pieces), can be placed in a relative thin walled canister; the canister is then filled with melted glass and allowed to solidify.

Thus, the present disclosure describes implementations of a hazardous waste repository in which waste (e.g., vitrified waste) is stored within a deep, human-unoccupiable borehole (e.g., vertical, slant, directional, horizontal, or combination thereof) and enclosed within a high level waste canister that includes a housing that is insufficient to withstand the hydrostatic pressures present at the disposal depth, typically 100 atmospheres of pressure for each kilometer of depth, without deformation (e.g., being crushed), due to, for example, the vitrified waste (and in some cases, in combination with a fluid inserted into the canister to fill a volume not taken by the waste or otherwise) providing at least some measure of crush resistance in addition to the housing of the canister. Other forms of non-vitrified waste, such as waste that provides some measure of crush resistance, can also be enclosed within the high level waste canister.

Further, the housing of the high level waste canister is, relative to an outer, thick canister described herein, smaller and with a thinner wall. From the discoveries listed previously (including sufficiency of geologic isolation, high crushing strength of vitrified or other filled canisters) everything can be eliminated from the waste package except for the vitrified waste.

In some aspects, the high level waste canister has a housing that is formed of a material that provides no barrier or an insufficient barrier to radiation (e.g., gamma) that can travel from the enclosed radioactive waste, through the housing, to an environment that surrounds the high level waste canister.

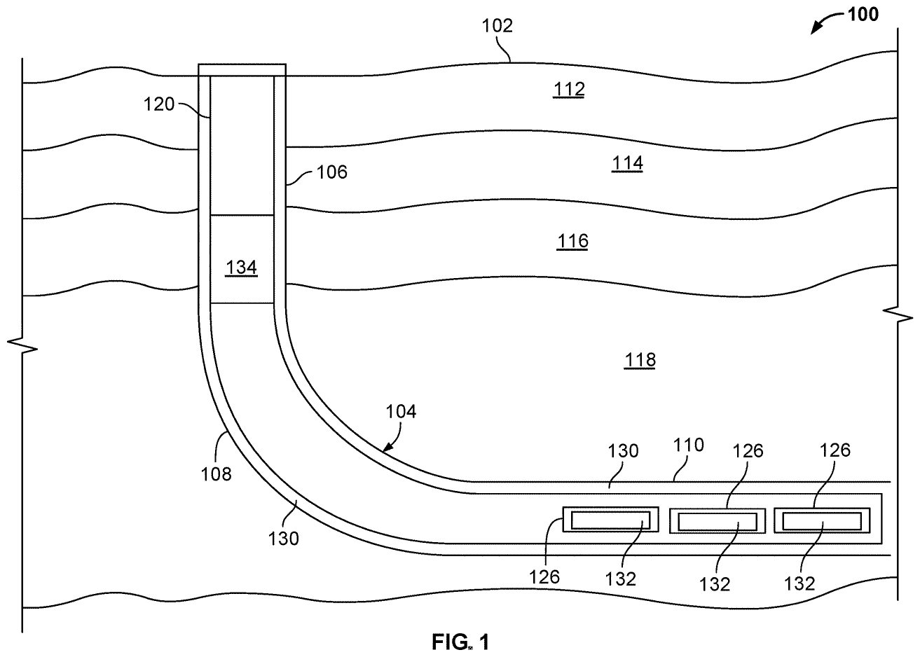

FIG. 1 shows an example implementation of a hazardous waste repository 100. Hazardous waste repository 100, in this example, utilizes a subterranean location for the long-term (e.g., tens, hundreds, or thousands of years or more) but retrievable safe and secure storage of hazardous material that is, in this example, in the form of vitrified radioactive waste. In this example, the vitrified hazardous waste 132, or just vitrified waste 132 (e.g., radioactive, chemical, or biological waste or a combination thereof) is enclosed in high level waste canisters (HLWCs) 126. In the present disclosure, “vitrified waste” is one or more waste forms (such as highly radioactive spent nuclear fuel and/or other forms of nuclear waste) that has undergone chemical separating and mixed with molten glass; the mixed waste and glass (solidified through cooling) comprises a waste package (i.e., the vitrified waste) that can be enclosed within a HLWC 126.

Such vitrified waste 132, in some examples, can be biological or chemical waste or other biological or chemical hazardous material. In some examples, the vitrified waste 132 can include nuclear material, such as spent nuclear fuel recovered from a nuclear reactor (e.g., commercial power or test reactor) or military nuclear material. For example, nuclear material that can be combined with molten glass and formed into vitrified waste 132 can include one, some, or all of the following forms (alone or in combination):
(1) Cesium-137 and Strontium-90, currently in temporary storage at the U.S. Hanford Laboratory. This form of nuclear waste consists of capsules that are 9 cm (3.5 inches) in diameter and 60 cm (24 inches) long.
(2) Spent nuclear fuel from commercial nuclear reactors. This form of nuclear waste consists of 1-cm size pellets held in “fuel assemblies” that are rod shaped and typically 20 to 30 cm in diameter (diagonal length in an approximately square cross-section) and 4 m long.
(3) Previously vitrified waste. This form of nuclear waste is nuclear fuel that may have been reprocessed but is currently encased in glass. The glass serves as an “engineered barrier” to absorb short-range nuclear radiation (e.g., alpha and beta particles) and to partially contain radionuclides that can diffuse out from the nuclear fuel. The cylinders of glass are typically 30 to 45 cm in diameter and 3 meters long.
(4) Fragments of melted core from nuclear accidents. This form of nuclear waste generally does not have a standardized shape or size.
(5) Calcine waste. This form of nuclear waste is formerly liquid but has been converted to a granular solid in no standardized shape or size.
(6) Fourth generation nuclear reactor waste. This form of nuclear waste can come in many types. One example type includes the fuel for “pebble bed” nuclear reactors that consists of 6.7 cm (2.6 inches) diameter pellets (e.g., about the size of tennis balls). If this fuel is reprocessed (and some of it is intended for that), then the final format of the fuel may not be determined.
(7) Transuranic (or TRU) waste. This form of nuclear waste is currently disposed at the Waste Isolation Pilot Plant in New Mexico within 15 or 30 gallon drums (with diameters between 14 and 19 inches).

As illustrated, the hazardous waste repository 100 includes a drillhole (or borehole or wellbore) 104 formed (e.g., drilled or otherwise) from a terranean surface 102 and through one or more subterranean layers 112, 114, 116, and 118. Although the terranean surface 102 is illustrated as a land surface, terranean surface 102 may be a sub-sea or other underwater surface, such as a lake or an ocean floor or other surface under a body of water. Thus, the present disclosure contemplates that the drillhole 104 may be formed under a body of water from a drilling location on or proximate the body of water.

The illustrated drillhole 104 is a directional wellbore in this example of hazardous waste repository 100. For instance, the drillhole 104 includes a substantially vertical portion 106 coupled to a radiussed or curved portion 108, which in turn is coupled to a substantially horizontal portion 110. As used in the present disclosure, “substantially” in the context of a wellbore orientation, refers to wellbores that may not be exactly vertical (e.g., exactly perpendicular to the terranean surface 102) or exactly horizontal (e.g., exactly parallel to the terranean surface 102). In other words, those of ordinary skill in the drill arts would recognize that vertical wellbores often undulate offset from a true vertical direction, that they might be drilled at an angle that deviates from true vertical, and horizontal wellbores often undulate offset from a true horizontal direction. Further, the substantially horizontal portion 110, in some aspects, may be a slant wellbore or other directional wellbore that is oriented between exactly vertical and exactly horizontal. Further, the substantially horizontal portion 110, in some aspects, may be a slant wellbore or other directional well bore that is oriented to follow the slant of, e.g., subterrane formation 118. As illustrated in this example, the three portions of the drillhole 104—the vertical portion 106, the radiussed portion 108, and the horizontal portion 110—form a continuous drillhole 104 that extends into the Earth. However, drillhole 104 can be any vertical, slant, directional, horizontal wellbore, or a combination thereof.

The illustrated drillhole 104, in this example, has a casing 120 positioned and set around the drillhole 104 from the terranean surface 102 and can consist of one or multiple casing types or dimensions; however, the present disclosure also contemplates that at least a portion of drillhole 104 is an open hole completion as well. The surface layer 112, in this example, is a geologic layer comprised of one or more layered rock formations. In some aspects, the surface layer 112 in this example may or may not include freshwater aquifers, salt water or brine sources, or other sources of mobile water (e.g., water that moves through a geologic formation). In some aspects, the casing 120 may isolate the drillhole 104 from such mobile water and may also provide a hanging location for other casing strings to be installed in the drillhole 104.

As shown, cement 130 is positioned (e.g., pumped) around the casing 120 in an annulus between the casing 120 and the drillhole 104. The cement 130, for example, may secure the casing 120 (and any other casings or liners of the drillhole 104) through the subterranean layers under the terranean surface 102. In some aspects, the cement 130 may be installed along the entire length of the casings (e.g., casing 120 and any other casings), or the cement 130 could be used along certain portions of the casings if adequate for a particular drillhole 104. The cement 130 can also provide an additional layer of confinement for the hazardous material in HLWCs 126.

The present disclosure contemplates that there may be many other layers between or among the illustrated subterranean layers 112, 114, 116, and 118. For example, there may be repeating patterns (e.g., vertically), of one or more of the mobile water layer 114, impermeable layer 116, and storage layer 118. Further, in some instances, the storage layer 118 may be directly adjacent (e.g., vertically) the mobile water layer 114, i.e., without an intervening impermeable layer 116.

In some aspects, storage layer 118 can comprise shale or other rock formation, e.g., that includes an amount of clay material. Alternatively, storage layer 118 can comprise a salt formation. However, other types of rock formations (e.g., granite, sedimentary, or otherwise) are also contemplated by the present disclosure as appropriate for the storage of the vitrified waste 132. In some aspects, as noted, the drillhole 104 can be lined with the casing 120 or completed open hole. Some formations, such as salt, can be made smooth enough that casing 120 is not required. In some instances, the casing 120 can be used during placement and during a period when the possibility of retrieval of one or more of the HLWCs 126 may be mandated. Then the casing 120 can be removed to provide greater protection from material moving back up the drillhole 104, since diffusion into surrounding rock formation(s) provides protection from waste reaching the surface. It is also possible to use a slotted casing so that any rising waste in the drillhole 104 used to access the disposal region can diffuse into the surrounding rock formations 118 or 116.

As shown, one or more HLWCs 126 are positioned in the substantially horizontal portion 110 of the drillhole 104. A seal 134 is placed in the drillhole 104 between the location of the HLWCs 126 in the substantially horizontal portion 110 and an opening of the substantially vertical portion 106 at the terranean surface 102 (e.g., a well head). In this example, the seal 134 is placed at an uphole end of the substantially vertical portion 108. Alternatively, the seal 134 may be positioned at another location within the substantially vertical portion 106, in the radiussed portion 108, or even within the substantially horizontal portion 110 uphole of the canisters 126. In some aspects, the seal 134 may be placed at least deeper than any source of mobile water, such as the mobile water layer 114, within the drillhole 104. In some aspects, the seal 134 may be formed substantially along an entire length of the substantially vertical portion 106.

Prior to a retrieval operation, the seal 134 may be removed. For example, in the case of a cement or other permanently set seal 134, the seal 134 may be drilled through or otherwise milled away. In the case of semi-permanent or removable seals, such as packers, the seal 134 may be removed from the drillhole 104 through a conventional process as is known.

In this example, the HLWC 126 is not sufficient to withstand a hydrostatic pressure when emplaced in the drillhole 104 (e.g., within storage formation 118) with at least some deformation (including crushing). However, in example implementations, the HLWC 126, itself, is not enclosed within an outer, thick canister that is sufficient to withstand the hydrostatic pressures present at the disposal depth.

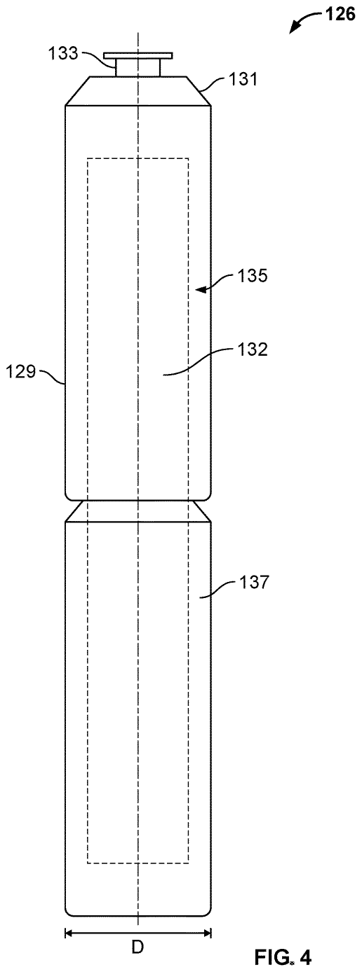

FIG. 4 shows an example implementation of the HLWC 126. In this example, the HLWC 126 includes a relatively thin-walled (e.g., metal) housing 129 (i.e., a housing not sufficient to withstand hydrostatic pressure within the storage formation 119 without at least some deformation, including crushing). A cap 131 can be secured to the housing 129 (e.g., threadingly, by welding including spin welding, or otherwise) to define an inner volume 135 sized to receive the vitrified waste 132. As shown in this example, a portion of the volume 135 that is not taken by the vitrified waste 132 can be filled with a fluid 137 (e.g., a gas such as an inert gas, or a liquid, or a mixed phase fluid). The fluid 137, along with the vitrified waste 132, can provide a measure of crush resistance for the housing 129 when the MLWC 126 is positioned at depth in which a hydrostatic pressure at the depth would (without the vitrified waste 132, the fluid 127, or both) deform or crush the housing 129.

As shown in this example, the cap 131 (or housing 129) can include a knob 133, which facilitates coupling to a downhole conveyance, such as a wireline, coiled tubing, drill pipe, or other lowering means, to be lowered into the drillhole 104. For example, a grappler (not shown) can be coupled to (and decoupled from, to release the HLWC 126) the knob 133. In other example implementations, a basket can be used to hold the HLWC 126. A rounded lower surface might be added, either to the HLWC 126 or to the basket, to minimize a danger that the canister 126 will be impeded by an unevenness on the inner surface of the casing 120, or on the rock formation if no casing is used.

As some examples, by using the HLWC 126 that stores vitrified waste 132 exclusive of any additional canister designed to withstand the hydrostatic pressure at depth of the storage formation 118 without deforming, a diameter of the drillhole 104 can be reduced. For example, the diameter, D, of the HLWC 126 can be about, or no greater than about, 45 cm. Comparatively, as shown in FIG. 2, a heavy (i.e., thick walled) canister 200 that is designed to withstand the hydrostatic pressure at depth of the storage formation 118 without deforming can have a diameter, DT, up to 90 cm. The reduction of size in a drillhole needed to accept and enclose the heavy canister 200 (at least 90 cm) to a drillhole needed to accept and enclose the HLWC 126 (at least 45 cm) can significantly reduce a cost of drilling the drillhole 104. Furthermore, a reduced weight (from the thick canister 200 to the HLWC 126) reduces the handling costs incurred in handling on the terranean surface 102. When being lowered into a directional, vertical, or slanted borehole (such as drillhole 104), several HLWCs 126 can be attached to each other to reduce the number of cycles of running into the drillhole 104 that are required.

In example implementations, the heavy canister 200 shown in FIG. 2 can be emplaced in the drillhole 104 rather than just one or more HLWCs 126. For example, as shown, the heavy canister 200 includes a housing 202 onto which a cap 204 is attached (e.g., threadingly, by welding, or otherwise) to define an inner volume 206. In example implementations, one or more (three as shown in this example) HLWCs 126 can be inserted into the volume 206 and then enclosed therein. As previously described, the heavy canister 200 can withstand hydrostatic pressures encountered at a disposal depth (e.g., in storage formation 118) without deformation or with minimal deformation.

As an illustrative example, consider the vitrified waste 132 shown in FIG. 2. The heavy canister 200 holds three HLWCs 126, each with diameter of no more than about 45 cm (e.g., 430 mm or 43 cm). These HLWCs 126 have thin metal walls into which the molten glass/waste combination was poured and then cooled. Before placement into the heavy canister 200, the glass/waste combination is cooled into a glassy solid referred to as the vitrified waste 132. Such vitrified waste 132, because it is a solid, is highly resistant to crushing. For that reason, no additional canister (including heavy canister 200) is needed to prevent the HLWCs 126 from collapsing from hydrostatic pressure as it is lowered into the drillhole 104. Thus, while the addition of the heavy canister 200 can provide more protection to the vitrified waste 132, such protection comes at a cost that is not commensurate (i.e., is greater than) the corresponding added value.

An additional aspect of the challenge of disposing of the vitrified waste 132 by using HLWCs 126 enclosed within the heavy canister 200 is the large diameter of the heavy canister 200 shown in FIG. 2. The housing 202 can be 0.8 to 1 meter in diameter, Dr. Such a canister 200 requires a borehole that is substantially larger to contain both it and the casing that typically surrounds the canister 200 relative to a borehole formed to accept and enclose HLWCs 126. Thus, while the heavy canister 200 can be emplaced into the drillhole 104, thereby emplacing one or multiple HLWCs 126, the HLWCs 126 can be disposed in boreholes without need for a heavy canister 200.

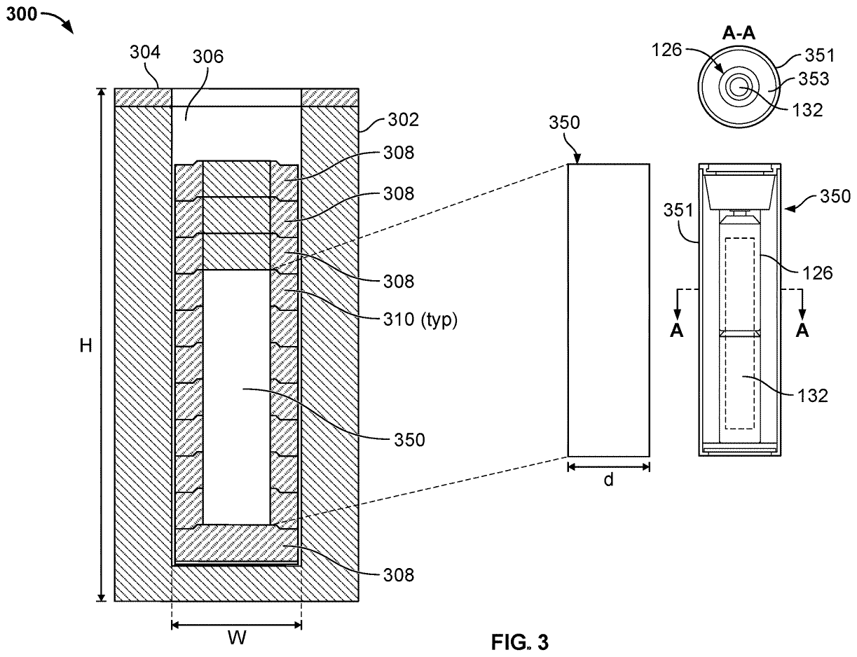

In some aspects, the HLWC 126 can be used to transport or store the vitrified waste 132 in conventional waste casks that, for instance, can be used to store waste in a mined (i.e., human occupiable) waste repository. For example, FIG. 3 shows vitrified waste 132 as secured in a HLWC 126, which in turn is secured within an outer canister 350, which in turn is secured in a large outer cask 300 intended for a mined (i.e., human-occupiable) repository disposal.

For example, as shown in FIG. 3, the outer cask 300 includes a concrete (or other cementitious) housing 302 to which a cap or lid 304 can be secured to define an inner volume 306. As is typical, the cask 300 is large compared to the HLWC 126 and is, e.g., about 5.6 to 6.75 meters in height, H, with the inner volume 306 having a width, W, of about 1.75 m. Multiple plugs 308 (e.g., made of bentonite) can be stacked within the inner volume 306 and, along with rings 310 (e.g., made of bentonite), enclose the outer canister 350. In FIG. 3, the plugs 308 and rings 310 can provide waste isolation, that is, they retard the movement of external water or brine to the waste within the heavy canister 350.

As further shown in FIG. 3, the heavy canister 350 includes a housing 351 (e.g., a copper housing) that defines a volume to receive the HLWC 126. The heavy canister 350, in this example, has a diameter, d, of about 90 cm (still much larger than the 45 cm of the HLWC 126). As shown in FIG. 3 (and section “A-A”), a cast iron insert 353 can be placed in the housing 351 to surround the HLWC 126. The cast iron insert 353 is designed to provide protection for workers in the mined repository. As described, the HLWC 126 is the innermost container that holds the vitrified waste 132. This “package” (i.e., a HLWC 126 within a heavy canister 350 within a cask 300) can be used to store vitrified waste 132 in a mined, human-occupiable repository.

In particular, in a mined repository, the HLWC 126 (which may offer little to no barrier to radiation transmission therethrough) may need to be enclosed in, e.g., the outer canister 350 and waste cask 300 (one or both of which does offer a barrier to radiation transmission therethrough) during and subsequent to emplacement within the mined repository, i.e., during human handling. In contrast, when emplacing the HLWC 126 into a deep, directional (and human-unoccupiable) drillhole, such radiation protection can be provided separately at an entry of the drillhole (on the terranean surface) but once inserted into the drillhole, such radiation protection is not needed in the drillhole. Thus, the lack of requirement of radiation protection in the drillhole can also be an advantage for the emplacement of the HLWC 126 (without the outer or heavy canister or cask).

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

1. A hazardous waste repository, comprising:
a drillhole formed from a terranean surface and through one or more subterranean formations, the drillhole comprising a storage portion formed within at least one of the one or more subterranean formations; and
a portion of vitrified hazardous waste enclosed in a housing of at least one high level waste canister (HLWC) exclusive of an outer canister, the HLWC positioned in the storage portion, wherein a volume of the HLWC is completely filled with: (1) the portion of vitrified hazardous waste; or (2) the portion of vitrified hazardous waste and a fluid.

2. The hazardous waste repository of claim 1, wherein the housing of the HLWC is solely insufficient to withstand a hydrostatic pressure present in the storage portion without deformation, and a housing of the outer canister is solely sufficient to withstand the hydrostatic pressure present in the storage portion without deformation.

3. The hazardous waste repository of claim 1, wherein the housing of the HLWC is approximately 45 cm in diameter.

4. The hazardous waste repository of claim 1, wherein the vitrified hazardous waste comprises at least one of vitrified nuclear waste, vitrified chemical waste, vitrified biological waste, or a crush resistant waste package.

5. The hazardous waste repository of claim 4, wherein the nuclear waste comprises at least one of:
Cesium-137 or Strontium-90 capsules;
spent nuclear fuel pellets;
vitrified nuclear waste that comprises glass-encased nuclear fuel;
one or more fragments of a melted nuclear core;
calcine waste that comprises a granular solid;
pebble bed nuclear reactor pellets; or
a portion of transuranic waste.

6. The hazardous waste repository of claim 1, wherein the housing of the HLWC comprises an attachment member formed at or coupled to an end of the housing.

7. The hazardous waste repository of claim 6, wherein the attachment member comprises a knob.

8. The hazardous waste repository of claim 6, wherein the attachment member is configured to attach to a downhole conveyance.

9. The hazardous waste repository of claim 8, wherein the downhole conveyance comprises one of a wireline, slickline, coiled tubing, drill pipe, or downhole tractor.

10. The hazardous waste repository of claim 1, further comprising a casing installed in the drillhole.

11. The hazardous waste repository of claim 1, further comprising a seal positioned in the drillhole.

12. A method of storing hazardous waste, comprising:
identifying a drillhole formed from a terranean surface and through one or more subterranean formations, the drillhole comprising a storage portion formed within at least one of the one or more subterranean formations; and
moving a portion of vitrified hazardous waste enclosed in a housing of a high level waste canister (HLWC) exclusive of an outer canister into position in the storage portion, wherein a volume of the HLWC is completely filled with: (1) the portion of vitrified hazardous waste; or (2) the portion of the vitrified waste and a fluid.

13. The method of claim 12, wherein the housing of the HLWC is solely insufficient to withstand a hydrostatic pressure present in the storage portion without deformation, and a housing of the outer canister is solely sufficient to withstand the hydrostatic pressure present in the storage portion without deformation.

14. The method of claim 12, wherein the housing of the HLWC is approximately 45 cm in diameter.

15. The method of claim 12, wherein the vitrified hazardous waste comprises at least one of vitrified nuclear waste, vitrified chemical waste, vitrified biological waste, or a crush resistant waste package.

16. The method of claim 15, wherein the nuclear waste comprises at least one of:
Cesium-137 or Strontium-90 capsules;
spent nuclear fuel pellets;
vitrified nuclear waste that comprises glass-encased nuclear fuel;
one or more fragments of a melted nuclear core;
calcine waste that comprises a granular solid;
pebble bed nuclear reactor pellets; or
a portion of transuranic waste.

17. The method of claim 12, comprising coupling a downhole conveyance to an attachment member formed at or coupled to an end of the housing of the HLWC.

18. The method of claim 17, wherein the attachment member comprises a knob.

19. The method of claim 17, comprising moving the HLWC on the downhole conveyance through the drillhole while coupled to the attachment member.

20. The method of claim 19, wherein the downhole conveyance comprises one of a wireline, slickline, coiled tubing, drill pipe, or downhole tractor.

21. The method of claim 12, wherein the drillhole further comprises a casing installed in the drillhole.

22. The method of claim 12, wherein the drillhole further comprises a seal positioned in the drillhole.

23. The hazardous waste repository of claim 1, wherein the fluid is a liquid.

24. The hazardous waste repository of claim 1, wherein the fluid is an inert gas.
